(19) United States
(12) Patent Application Publication
(10) Pub. No.: US 2006/0045228 A1
(43) Pub. Date: Mar. 2, 2006

(54) Dual-plasma fusion and fission fuel cells

(75) Inventors: James ShihFu Shiao, Stow, OH (US); Albert ShihYung Shiao, Stow, OH (US); Frank ShihChiang Shiao, Stow, OH (US)

Correspondence Address: Law Offices of John D. Gugliotta, PE, Esq., 202 Delaware Building, 137 South Main Street, Akron, OH, 44308, US

(73) Assignee: Daw Shien Scientific Research & Development, Inc.

(21) Appl. No.: 10/970,152

(22) Filed: Oct. 22, 2004

Related U.S. Application Data
(63) Continuation-in-part of application No. 10/929,023, filed on Aug. 30, 2004.

(51) Int. Cl. H05H 1/22

(52) U.S. Cl. 376/127

(57) ABSTRACT

New [GOD, I], [GOD, II], & [GOD, III] dual-plasma fuel cells provide the electric start systems to start their warm-up processes, automatically. After their warm-up processes done and the operation temperatures reached, the dual-plasma fuel cells will run independently by continuously supplying fuels and moisture into the units. In dual-plasma nuclear [fusion and/or fission] fuel cells' configuration, electrical power will be generated from the nuclear-thermal-plasmas reaction by exothermal heating from combustion & nuclear reactions. With conducting high-electrons' current, the cable, loads, and electrodes are connected among one another between two plasmas' ionizing chambers for civil utility purposes. In the [GOD, II] dual-plasma fusion fuel cell, heavy water [D₂O] injection into the atomizing chambers increases the plasmas heating and electrical conductivities. And the un-like charges of the heavy water's [D₂O⁺], & [D₂O⁻] react with plasmas' [2H⁺& O⁼] combustion heating which will induce the fusion reaction and release much more nuclear heating power for initiation of the next plasmas-generation cycle much easily. For the [GOD, III] dual-plasma fission fuel cell, fission fuels located in the combustion & nuclear reaction space through robotic movements provide additional nuclear-thermal energy that allows for initiation of the plasmas-generation process for the next cycle. For [GerTh. I] dual-plasma jet thruster, the dual plasmas are ejected to an opening end of a ‘C’ shaped magnet, and linear thrust is generated, according to the right-hand rule as in a jet thruster of propulsion for space traveling.

### RELATED APPLICATIONS

The present invention is a Continuation in Part of U.S. Ser. No. 10/929,023 filed on Aug. 30, 2004 and incorporated by reference herein as if fully rewritten.

### BACKGROUND OF THE INVENTION

1. Field of the Invention

The present invention relates generally to thermal-plasmas generation methods for power and propulsion, more particularly, to a dual-plasma fuel cell that utilize fusion or fission to provide much higher current density, with no fast-moving parts (no turbines), and require less physical space than conventional methods.

2. Background of the Invention

In recent years, conventional fuel cell has developed its fuel cell as a galvanic cell in which the chemical property of a fuel is converted directly into electricity by means of electro-chemical processes. Fuel and oxygen are continuously and separately supplied to the two electrodes of the cell. The electrolyte is also diluted by the water (chemical reaction product) and may be concentrated through the concentrator and recycled back to the fuel cell. This conventional hydrogen-oxygen-electrolyte process takes place in the lower temperature ranges of approximately 40° C. to 50° C. The conventional hydrogen-oxygen-electrolyte fuel cell's electrochemical reactions are shown in following reaction equations:
Negative electrode: H₂→2H⁺+2e⁻+electrolyte
Positive electrode: ½O₂+2H⁺+2e⁻+electrolyte H₂O

Although capable of generating electricity, problems associated with such fuel cells include a limited current density and a slower conversion rate which result in the lower efficiency and require the more physical space.

The [GOD, I] Dual-Plasma Fuel Cell is the advanced process in related with direct conversion of chemical and combustion heat to ionize fuels into plasmas and transform plasmas into electrical energy.

The [GOD, II] dual-plasma fusion fuel cell and the [GOD, III] dual-plasma fission fuel cell (chemical-thermal-nuclear-electrical) processes have been some advanced in related with the direct conversion of chemical, and nuclear heating energy to ionize fuels into plasmas and transform plasmas into electrical energy directly without going through the fast-running gas turbines.

Several particles such as neutron and electron can serve to induce nuclear reactions and also to be products of the steady-state chain reactions. These photons, electrons, protons, neutrons, alpha particles, deuterons, and other charged particles as listed in Table 1, below.

TABLE 1
The Table And Properties of Elementary Particles.

| | | | | Mean Life |
|---|---|---|---|---|
| Class of | Particle and | | | Time |
| Particle | Antiparticle | Mass in m_{£} | Mass Ratios | (Seconds) |
| Photon | Y | 0 | 0 | Stable |
| Lepton | v v | 0 | 0 | Stable |
| | e⁻ e⁺ | 1 | 0.511 | Stable |
| | u⁻ u⁺ | 207 | 105.7 | 2.2 × 10⁻⁶ |
| Mesons | π⁻ π⁺ | 273.2 | 139.6 | 2.55 × 10⁻⁸ |
| | K⁻ K⁺ | 966.7 | 494.0 | 1.22 × 10⁻⁸ |
| Baryons | p p | 1836 | 938.2 | Stable |
| | n n | 1838 | 939.5 | 1.103 × 10³ |
| | Σ⁻ | 2340 | 1196 | 1.74 × 10⁻¹⁰ |
| | Σ⁺ | 2327 | 1189.4 | 0.8 × 10⁻¹⁰ |
| | ≡⁻ | 2580 | 1318 | 1.7 × 10⁻¹⁰ |

The useful outputs of nuclear fuel cells may be getting for more heating power to generate more plasmas, electricity, radiation, steam, and gas. Those outputs are used for production of propulsion, and public utilities. Table (2) gives the orders of magnitude of the energy produced per nuclear reaction from each of the mentioned conventional same-charges-repelling of high-energy-excited reaction types.

TABLE 2
The List of Conventional Incident/Released Nuclear
Fusion and Fission Reaction's Energies

| | | |
|---|---|---|
| Reaction Type | Energy Excited | Energy Rewarded |

| | | | | |
|---|---|---|---|---|
| Chemical | 1 | eV | 3-4 | eV |
| Fusion | 2-15 | MeV | 3-18 | MeV |
| Fission | 1 | MeV | 200 | MeV |

The conventional fusion reactors are built at near vacuum prior to heating. That simplest type design was the torus or doughnut shape (as in Tokamak Reactor), in which the current is induced by making the torus a one-turn secondary plasma coil of a large iron-core transformer. If the initial pressures are in the neighborhood of 10⁻⁴ atm, however, this resulting pressure can be unimaginably high when reaction temperature reaches millions of degree, and can not be handled with a number of known technical difficulties. Also, that massive hot plasma could be obtained only for microseconds, but hardly requiring operation on a repetitive cycle. This makes the engineering work impossible, even after decade's of development. Much attention has been paid to the design of the walls of that type reactor, which is imaged that should withstand large quantities pulsed fluxes of high-energetic particles went-off under almost vacuum state and walls are not succeeded to be stretched back and forth over a period of time which can not allow any media inside to absorb their radiant heat and to cool down the walls.

The key of understanding the strong forces holding the atomic nuclei together may lie in the internal structure of neutrons and protons. Both neutrons and protons respond to the electromagnetic forces and the scattering patterns for high energy electrons have indicated that nucleons may have an internal structure consisting of point particles which have been named partons, quarks, and strange particles (hyperons, mesons, etc. . . . )

For light element's fusion reaction, the conventional first same-charges excited state is normally several MeV (₃Li⁷ nucleonic binding energy is 5.61 MeV/nucleon.) above the ground level.

For heavy element's fission scatters are more prevalent, since their energy levels are only about 0.1 MeV apart near ground level. The differences in energy levels decrease to a few eV when it is at 8 MeV.

There is certain when enough energy is presenting in the given time, the excited isotope will be reacted. And the rate of reaction (dN/dt) is equal to the polynomial of the number of the excited nuclei present, N, and the incident energy amount, Eₑₙ, in presence for using for fasting the chain reaction rate or it can be simplified in the powers relationships.
−(dN/dt)=λ₀N+λ₁(Eₑₙ−E₀)N+λ₂(Eₑₙ−E₀)²N+λ₃(Eₑₙ−E₀)N²+ . . . etc.
−(dN/dt)=λ₀N+π_{T}(Eₑₙ−E₀)^{a}N^{b} for another simplified expression,
where E₀ is the same/or opposite charges Elastic Collision Energy, Eₑₙ is the amount of sum of incident and accumulated energy. λ₀, λ₁, λ₂, λ₃, and λ_{T} are the reaction rate's coefficients, a and b are powers' coefficients. For nuclear reaction (fusion of ₁D²⁺+₁D²⁺ being to ₂He⁴⁺⁺ (the α particle)) under tremendous energy, Eₑₙ>>E₀, this nuclear chain reaction is accomplished only less than a millionth second, but the Natural Nuclear Reaction (₁D²⁺+₁D²⁺ as being to ₂He⁴⁺⁺ (the α particle)) at ambient energy, Eₑₙ<<E₀, this reaction will take into a much longer than millions of year to finish its natural nuclear process. And its reaction equation will not be as the traditional nuclear reaction rate equation as
   −(dN/dt)=λ₀N; This were the mis-conceptive chain reaction rate's expression by Without dominating-energy terms in them.

Often the daughter of a radioactive isotope is not always stable and will react to be a third nuclide, which also can be unstable. In case of an element reacts under tremendously high energy to be unstable daughters, they will react to be other unstable isotopes, and the mechanism expressions can be rewritten for the numbers of atoms of each species.
−(dN₁/dt)=λ₀₁N₁+λ_{T1}(Eₑₙ−E₀₁)^{a1}N₁^{b1}
−(dN₂/dt)=(dN₁/dt)+λ₀₂N₂+λ_{T2}(Eₑₙ−E₀₂)^{a2}N₂^{b2}
−(dN₃/dt)=λ₀₁N₁+λ_{T1}(Eₑₙ−E₀₁)^{a1}N₁^{b1}−λ₀₂N₂−λ_{T2}(Eₑₙ−E₀₂)^{a2}N₂^{b2}+λ₀₃N₃+λ_{T3}(Eₑₙ−E₀₃)^{a3}N₃^{b3}

To solve these equations simultaneously, the digital computers are much powerful to handle these complicated series calculations unto 10⁻¹² seconds step sizes and will have probably good simulation answers for the powered nuclear fusion & fission problems, instead of just as the general discussions on natural ambient energy isotope decay reactions as in the prior art's equation.

Those high power induced conventional fusion and fission reactions occurring at tremendously high temperatures (10⁵-10⁶° K) will completely exhaust all isotopes immediately and just left few radioactive waste for a very short period of time.

In order for [same-charges'] fusion reaction occurring as in the conventional process, tremendous temperatures were used of today's technology and could not always do this in a controllable manner.

The newly proposed fast accelerated ‘+’ nuclei plasma and ‘−’ nuclei plasma collide into each other which must have sufficient kinetic energy caused by the electrostatic forces of attraction due to their unlike charges. Equations show the reaction energy for the fast moving nuclei moving toward each other:
D₂O⁺+D₂O⁻+exciting energy→2 He⁺⁺+2 O⁼+energy rewards of Fusion reaction
₉₂U²³⁵⁺+e⁻+exciting energy→Ba+Kr+4n^{o}+energy rewards of Fission reaction

Although the utilization of fission preceded that of fusion in weapons and power generation, the possible basic fusion reaction can be studied on an electron-particle accelerator so that it can be proved that this process produces the efficient fusion and fission reactions.

Therefore, these newly un-like plasmas induced fusion/or fission fuel cells will be proposed, designed and accomplished for the fusion/or fission fuel cells' reactions at medium temperatures and their processes utilize the electrical power directly.

A search of the prior art did not disclose any patent that reads directly on the claims of the present invention; however, the following references were considered relating and relevant to the present invention:
U.S. Pat. No. 6,660,417, issued in the name of Nishio et al., discloses a fuel cell that generates electricity using hydrogen, an electrolytic device that electrolyzes water using electricity from an external electricity system, a hydrogen storage device that stores hydrogen and then supplies the stored hydrogen to the fuel cell, a heat supplying device and a driving controller that drives the fuel cell so as to generate electricity during a first time period and drives the electrolytic device so as to electrolyze water during a second time period;
U.S. Pat. No. 6,654,433, issued in the name of Boscoli, discloses an experimental machine for producing low-temperature nuclear fusion reactions, wherein an ion source feeds a flux of positive deuterium ions to a reaction chamber;
U.S. Pat. No. 6,651,597, issued in the name of Daniel et al., discloses a plasmatron having an air jacket, the plasmatron reforming hydrocarbon fuels so as to produce reformed gas further supplied to a remote device such as an internal combustion engine or fuel cell;
U.S. Pat. No. 6,628,740 & U.S. Pat. No. 6,611,106, issued in the name of Monkhorst et al., disclose a system for controlled fusion in a field reversed configuration (FRC) magnetic topology and conversion of fusion product energies directly to electric power. Preferably, plasma ions are magnetically confined in the FRC while plasma electrons are electrostatically confined in a deep energy well, created by tuning an externally applied magnetic field. And energy is removed from the fusion product ions as they spiral past electrodes of an inverse cyclotron converter;
U.S. Pat. No. 5,793,831, U.S. Pat. No. 5,526,386, & U.S. Pat. No. 5,457,721, issued in the name of Tsiklauri, et al., disclose a method and apparatus for improving the efficiency and performance of the electicity generation from a steam driven power plant;
U.S. Pat. No. 5,608,767, issued in the name of Terhune, et al., discloses a device for generating direct current by neutron activation of a plurality of series-connected beta-emitter cells, located in the out-of-core region of a light water nuclear reactor;
U.S. Pat. No. 5,160,694, issued in the name of Steudtner et al., discloses a fusion reactor based on the cusped geometry concept in which the problem of indefinite tight plasma containment with inherent stability and high compression of the contained plasma in the reaction zone is solved by an electric potential pot surrounding the reaction zone and having an ion source at the upper potential pot edge;
U.S. Pat. No. 4,563,327, issued in the name of Minkov, discloses a nuclear fission reactor having a core vessel and at least one tandem heat exchanger vessel;
U.S. Pat. No. 4,327,443, issued in the name of Cotton, discloses capillary liquid fuel elements, created by the method of confining a liquid fuel in horizontal capillary troughs, are employed to create the core of a nuclear reactor;
U.S. Pat. No. 4,121,969, issued in the name of Marwick, discloses a nuclear reactor system which produces useful thermal power and breeds fissile isotopes wherein large spherical complex slugs containing fissile and fertile isotopes;
U.S. Pat. No. 4,102,740, issued in the name of Blum, et al., discloses a moderator structure placed within a core space limited by a bottom wall;
U.S. Patent Application Publication No. 2001/0026893 A1, filed under the name of Asukabe et al., discloses a grafted polymer electrolyte membrane for use in a proton-exchange membrane fuel cell or for electrolysis of water;
U.S. Patent Application Publication No. 2003/0224232 A1, filed under the name of Browall et al., discloses a method for manufacturing a fuel cell assembly;
U.S. Patent Application Publication No. 2004/0001993 A1, filed under the name of Kinkelaar et al., discloses a gas diffusion layer for fuel cells formed from a porous material comprising a solid matrix and interconnected pores having at least one external surface and internal surface, and wherein the external surface is coated with one or more layers of at least one electrically conductive material;
U.S. Patent Application Publication No. 2004/0018416 A1, filed under the name of Choi et al., discloses carbon nanotubes for fuel cells doped with nano-sized metallic catalyst particles;
U.S. Patent Application Publication No. 200410033411 A1, filed under the name of Lersch et al., discloses a fuel cell module comprising a magnetic shielding;
U.S. Patent Application Publication No. 2004/0028962 A1, filed under the name of Stolten et al., discloses a fuel cell stack with circuit; and
U.S. Patent Application Publication No. 2004/0030469 A1, filed under the name of MacBain, discloses a method and control system for controlling propulsion in a hybrid vehicle.

### SUMMARY OF THE INVENTION

Therefore an object of the present invention provides the improved thermal-plasmas generation methods for the utility power and propulsion.

These new designs of [GOD, I], [GOD, II], & [GOD, III] dual-plasma fuel cells have tremendously high current densities which are more efficient than the conventional fuel cells;

The new [GOD, I] dual-plasma fuel cell has operation wall temperatures (2,200° C.-2,700° C.) and the [GOD, II] & [GOD, III] dual-plasma fusion & fission fuel cells have operation wall temperatures (2,700° C.-3,000° C.), which will generate higher voltage and amperage, and generate much higher power than the conventional fuel cells;

These new dual-plasma fuel cells with the electric starters only need a short of warming-up time period and after that they can sustain themselves and generate electricity automatically by only continuously replenishing nuclear fuels, hydrogen, oxygen, and humidity into these units.

It is an innovation of the present invention to provide an improved a dual-plasma fuel cell that can also utilize fusion/or fission reaction to provide more nuclear heating power to generate more electricity, higher current density, without fast-moving parts, and requiring less physical space than conventional fusion & fission methods.

There are several significant advantages of these advanced [GOD, II] dual-plasma fusion fuel cell and the [GOD, III] dual-plasma fission fuel cell with electric starter designs, which are listed as in the followings:
There are no fast-moving parts (such as no high tech's turbines) in these new electrical power generation stations;
The physical sizes of these new power generating stations will be significantly reduced compared to conventional nuclear power generating plants;
The [GOD, II] dual-plasma fusion fuel cell and the [GOD, III] dual-plasma fission fuel cell are the long life and durable devices. By cautiously requiring radiation-prevention maintenance, they will have a minimal down-time.

### DESCRIPTION OF THE PREFERRED INNOVATIONS

The advantages and the present invention will become better understood with referencing to the following more detailed descriptions and claims taken in conjunction with the accompanying drawings, in which like elements are identified with like symbols, and in which:

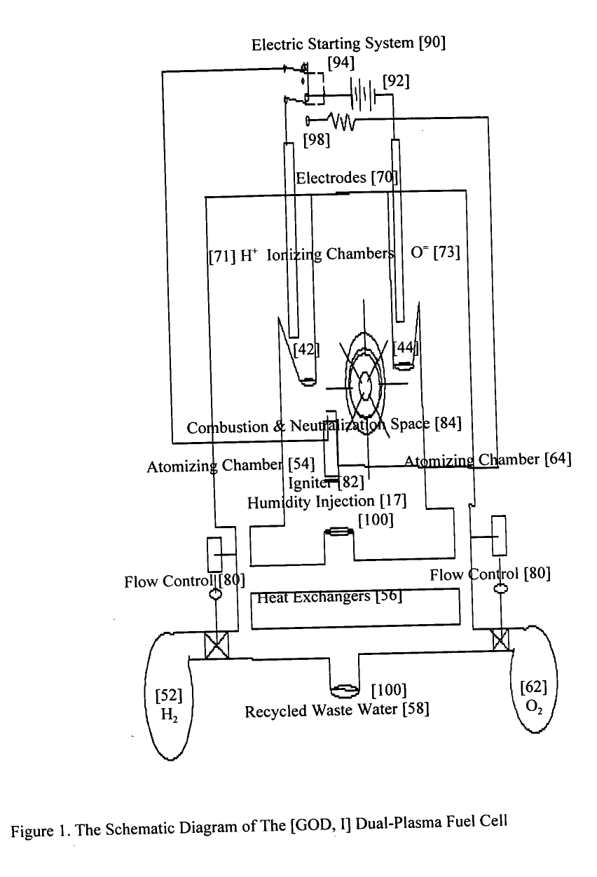

FIG. 1 is a schematic diagram of The [GOD, I] dual-plasma fuel cell according to the present invention;

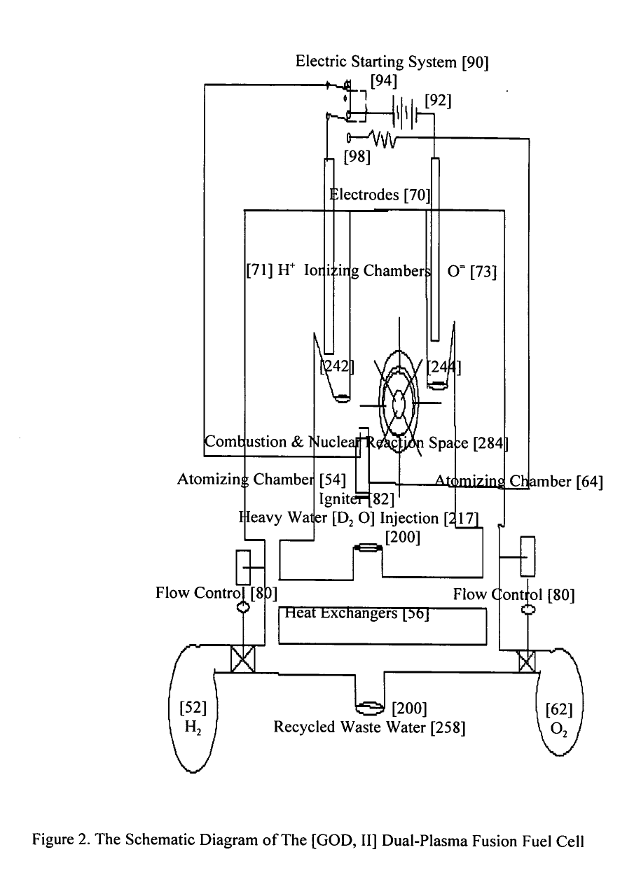

FIG. 2 is a schematic diagram of The [GOD, II] dual-plasma fusion fuel cell utilizing a fusion energy source to the electrical power according to the present invention; and

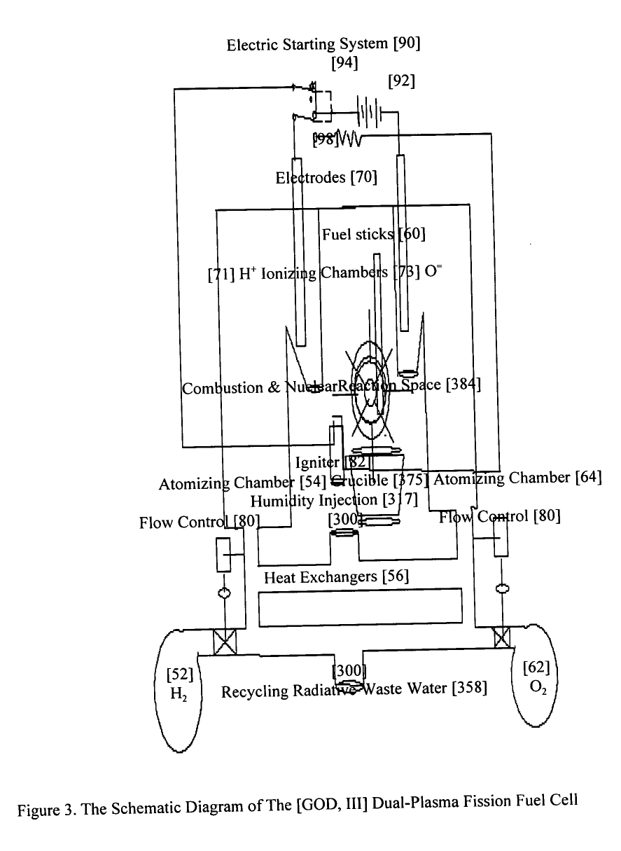

FIG. 3 is a schematic diagram of The [GOD, III] dual-plasma fission fuel cell utilizing a fission energy source to the electrical power according to the present invention; and

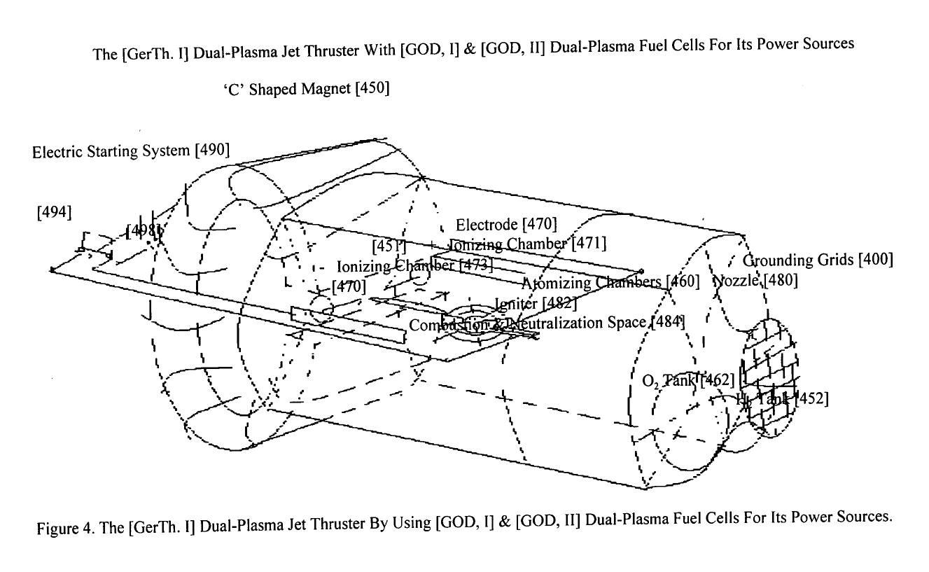

FIG. 4 is a schematic diagram of The [GerTh. I] dual-plasma jet thruster of by using The [GOD, I] & [GOD, II] dual-plasma fuel cells as its power sources.

### DESCRIPTION OF THE PREFERRED INNOVATIONS

The best mode for describing the invention is presented in terms of its preferred innovations, herein depicted within the FIGS. 1 through 4.

1. Detailed Description of the Figures

Referring now to FIG. 1, a new [GOD, I] Dual-Plasma Fuel Cell is summarized as described in the parent application of U.S. Ser. No. 10/929,023 and incorporated by reference herein as if fully rewritten.

As shown, as in FIG. (1), first we switch the normally-opened starter/igniter interlock switches [94] close. Let high voltage starter battery [92] charge the electrodes [70] and inlet gases in ionizing chambers [71] & [73]. Then, use the ignition system [82] to start the combustion process of the charged hydrogen [42] and oxygen [44] plasmas in the combustion & neutralization space [84]. The combustion heat will transform the next cycle's molecules into plasmas gradually during the warm-up time period. After temperatures are reached, the warm-up process is done and the dual-plasma fuel cell will generate the steady plasmas' flows by its combustion heat, instead of by the former starter battery's high electric voltage [92]. Then, switch ‘OFF’ the starter/igniter interlock switches [94], and turn the operation load switch [98] ‘ON’ at the same time. Then, start running the fuel cell, and generate electricity by continuously supplying fuel [52], oxygen [62], and humidity [17] into the unit to increase the ‘+ & −’ plasmas' electrical conductivities.

The electricity generation mechanism is derived from the advanced dual-plasma fuel cell's principles of operation, illustrated in terms of the hydrogen plasma [42]—oxygen plasma [44] combusted in the medium temperatures (2,200° C.-2,700° C.). The flame provides heat to transform H₂ molecules [52] to H atoms [54] and H⁺ plasma [42] and also transform O₂ molecules [62] to O atoms [64] and then to O⁼ plasma [44] in their respective atomizing chambers and ionizing chambers [71] & [73], in which electrodes [70] are connected with the cable [98]. The electrodes [70] with cable [98] down into the ionizing chambers [71] & [73] to make it capable to transform H atoms into H⁺ ionized plasma [42] and also transform O atoms into O⁼ ionized plasma [44] through this cable [98], simultaneously. In this cable [98], electrons taken from the hydrogen atoms pass through the loads [98] then through the cable connected to the electrode [70] in the oxygen ionizing chamber [73] provide the electrons to ionize the oxygen atoms, O, [64] into oxygen plasma, O⁼, [44]. The electrodes/cable combinations act as terminals of a DC voltage source, and through this cable, negative electrode is on the hydrogen side [71] and positive electrode is on the oxygen side [73], which are similar to the conventional fuel cell's. Humidity [17] is injected into the atomizing chambers [54] & [64] to increase the ‘+ & −’ plasmas' electrical conductivities. These relationships are shown as in the followings:

Negative electrode:
2H+heat+Cable+Humidity→2H⁺+2e⁻ (electric current flow);

Positive electrode:
O+heat+Cable+Humidity+2e⁻ (electric current flow)→O⁼

Note that this cabling process [92] & [98] and humidity injection [17] will lower the O⁼ plasma's [44] ionized temperatures approximately from 4,500° K down to 2,500° K. The electric cable connects with electric loads [98] to provide power to the loads [98] and electrons to the positive electrode [70]. The ionizing pipes [42] & [44] direct and guide the heated H⁺ plasma and O⁼ plasma into the combustion & neutralization space [84] where the heated H⁺, and O⁼ Dual Plasmas meet and get combusted. Then, the plasmas combustion and neutralization processes [84] release a great amount of thermal energy to heat the atomizing chambers [54] & [64] and ionizing chambers [71] & [73] for the next cycle stage-wise, which transform molecules into plasmas. The equations are shown as:

Combustion & Neutralization Reactions:
2H⁺+O⁼→Steam+heat heating up atomizing chambers and ionizing chambers+dynamic-electricity-for-jet-thruster's

Negative Electrode Side:
H₂+heat→2H;
2H+heat+Cable+Humidity→2H⁺+2e⁻ (electric current flow)

Positive Electrode Side:
O₂+heat→2O;
2O+heat+Cable+Humidity+4e⁻ (electric current flow)→2O⁼

The multiple-stage low-temperature heat exchanger [56] is for the steam-gas-liquid gases' heat exchanging and the grounding grids [100] prevent liquid gases [52] & [62] from being the electrified media down back into the storage tanks [52] & [62]. Those are insulated from the fuel cell's furnace [84] by connecting them with the ceramic tubing between the fuel cell's furnace [84] and the low-temperature heat exchanger [56]. And the furnace inner wall [84] is made of high-temperature-resistant Tantalum (Ta) alloys and it works like the high-temperature heat exchanger to conduct heat from the flame and high temperature steam to the gases hydrogen and oxygen to elevate their temperatures. Then, the hydrogen and oxygen hot gases are guided separately through heating baffle fins to their atomizing chambers [54] & [64] to be atoms which fins are also made of high-temperature-resistant Tantalum (Ta) alloys.

To get plasmas combusted and neutralized [84], we guide the ‘+’, & ‘−’ Dual-Plasma flows toward each other and are ignited [82] to be combusted & neutralized [84]. Then, they release tremendous heat which can be re-supplying the heat needed for atomizing and ionizing the hydrogen and oxygen molecules.

Finally, the joints between the ionizing chambers [71] & [73] and the ionizing pipes [42] & [44] (which are composed of metal and ceramic rings for insulation and avoid from abnormal electric shocks) and the joints are made of compacted rings which look like and work like piston rings, but those piston rings are connected back to back with no space in between for preventing plasmas leakage. The compacted rings form a gas-tight seal to prevent leakage. The diagram of the compacted rings is shown in the prior art.

High-temperature-resistant joint insulation sealing (mechanically be compacted rings and ceramic portion) eliminates any leakage due to the different thermal expansions between the Tantalum (Ta) alloys' wall and the outlet pipes.

The mechanisms of control plasmas [42] & [44] in this process will require controlling the liquid-gases mass flow rates [80], pressures, and temperatures of hydrogen and oxygen which flow out from storage tanks [52] & [62]. Because this new fuel cell will generate an extraordinary amount of current, those electric insulation equipments [100] are desperately needed. And the public's safety requirements of Grounding Grids [100] will be under seriously implemented.

As used in conjunction with FIG. 2, conventional fusion temperatures are around 25,000° C.-28,000° C. (as of ₉₄PU²³⁹'S inducing fusion reaction's temperature) in order to overcome the strong [same-charge]-repelling-forces: [D⁺+D⁺+huge energy→₂He⁴⁺+(the α particle)+releasing energy], and use awfully strong thermal energy to induce the same-charge fusion reaction in the conventional process.

This new [GOD, II] Dual-Plasma-Fusion Fuel Cell shown in FIG. 2 may use more heavy humidity [heavy water D₂O] [217] in the dual-plasma fuel cell and inject concentrated heavy water [217] into both atomizing chambers [54] & [64] also to increase the ionizing gases' heating and ‘+ & −’ electrical conductivities, respectively. And the ‘+’ plasma [H⁺. D₂O⁺] [242] will attract, and collide with ‘−’ plasma [O⁼. D₂O⁻] [244] in the combustion, fusion reaction, and neutralization space [284]. These ‘+’ plasma [H⁺. D₂O⁺] [242] & ‘−’ plasma [O⁼. D₂O⁻] [244] will attract, collide, react with each other by adding with combustion energy [284], and induce the fusion reaction easier at the medium temperature range [3,000° C. of the reaction temperature], instead of overcoming the conventional fusing the [same-charges] repelling-forces (D+with D+) at 25,000° C.-28,000° C. by chances, conditionally.

This new [GOD, II] Dual-Plasma-Fusion Fuel Cell is composed with these ‘+’ plasma [H⁺. D₂O+] [242] & ‘−’ plasma [O⁼, D₂O⁻] [244] fusion reaction, which will have extraordinarily high current density, higher output voltage, lower space requirements, medium reaction temperature range, and a significantly higher efficiency. Their fusion, combustion, and electricity generation reactions are totally listed in the followings:

Positive Electrode:
2H+D₂O+Cable+Heat→2H⁺+D₂O⁺+3e⁻[current flow]

Negative Electrode:
O+D₂O+Cable+Heat+3e⁻[current flow]→O⁼+D₂O⁻

Fusion & Combustion:
[2H⁺+D₂O⁺]+[O⁼+D₂O⁻]+combustion heating→H₂O[steam]+2He⁺⁺+2O⁼+[release nuclear energy]

Scientists have noticed that the energy released from the nuclear reactions is about a million times as great as from the chemical reactions.

These plasmas induced nuclear reactions are shown in Table (3)

TABLE 3
The Fast Accelerated Plasmas Induced [D₂O⁺ + D₂O⁻] Fusion &
[ e⁻ + ₉₂U²³⁵⁺] Fission Reactions

| Reaction Type | Reactants | Products | Energy Rewards |
|---|---|---|---|
| Induced Fusion (II) | D₂O⁺ + D₂O⁻ | 2He⁴⁺⁺ + 2O⁼ | — |
| Induced Fission (III) | e⁻ + ₉₂U²³⁵⁺ | Ba + Kr + 4n° | — |

Using high energy plasmas to induce the nuclear fuels shows the greatest promise as for the artificially producing fusion & fission reactions for following reasons:
(1) There is a very little probability of two same flowing direction with same charges' ‘+vs+’ deuterium nuclei collided against each other in a Tokamak Reactor at any time, and also while using the present technology, there are even much less possibility for that of four same-charges hydrogen ions ‘4++++’ with energy collided at the same time. The other 4-hydrogen reaction, such as occurs in the Sun, requires on a average longer time, while plasmas inducing deuterium-deuterium reaction requires less time period, and today's technology will be developed to achieve this reaction.

(2) The fast plasmas ‘+ & −’ induced fusion reaction (II): [D₂O⁺+D₂O⁻] the newly proposed plasmas fusion reaction will produce: [2 ₂He⁴⁺⁺+2 O⁼].

All natural waters on earth contain about 1 part in 6,500 of heavy water, D₂O. Heavy water is thus plentiful and may be concentrated by electrolysis, distillation, or chemical exchanging methods.

(3) The newly proposed fast electron plasma induced fission reaction (III): [e⁻+₉₂U²³⁵⁺] produces high temperature and elements Ba+Kr+4n^{o}.

FIG. 3 shown that the principles of controllable fission process are the needs for generating and maintaining high energy plasmas which will generate the reaction temperatures of thousands of degrees of Kelvin in a limited confined space.

Briefly described according to this fission process of the present invention, an advanced [GOD, III] dual-plasma fission fuel cell process is provided that uses dual-plasmas' highly opposite charges to induce the solidified cemented concentrated nuclear fuel sticks [60] (particular ₉₂U²³⁵, around with ₉₂U²³⁸) into molten metal and lava and then flow into the crucible [375], underneath. The solidified cement fission fuel sticks [60] are made of concentrated fuel particles ₉₂U²³⁵ surrounded with fertile ₉₂U²³⁸ particles which act as the raw fuel materials. In order to make those fuel sticks [60], these concentrated fuel particles and the tied raw fuel material will be totally immersed into the cement slurry and ready to be molded and dried into the fuel sticks [60]. While using ‘+ & −’ plasmas to induce the reactions in the fission process, the consuming fuel sticks [60] will be melted into molten lava of the reaction temperature at 10,000° K or above and the reaction residue lava drops flow into the crucible's Lead (Pb) tubes [375] which are set directly underneath the reacting fuel sticks [60] with filled up with Lead (Pb) as the heating and radiative moderator. The water is led into and be evaporated in the fission fuel cell's crucible's Lead (Pb) tubes [375] to absorb the reaction heat and maintain the fuel cell's chambers wall temperature under 3,000° C.

In FIG. 3 for The [GOD, III] dual-plasma fission fuel cell, the confined space is inside the crucible space [375] locally with Lead (Pb of s.g. 7.8) filled inside as the heating and radiative moderator. These technical difficulties will be controlled and resolved by through the basic micro-scale plasmas-induced-fission the fuels of a very small amount [60] and in a very limited region [375] at a time and by using the robust robots to operate the fission waste treatment.

The nuclear radiation hazard [358] and electric insulation [300] are two main seriously public safety demands. Their implementations are under serious considerations. The skilled-in-art agents may have some other modifications down the road, contemplatively.

FIG. 4 The Schematic Diagram of [GerTh. I] Dual-Plasma Jet Thruster is summarized as described in the parent application of U.S. Ser. No. 10/929,023 and incorporated by reference herein as if fully rewritten.

As shown, as in FIG. 4, the ‘C’ shaped magnet [450] is added to the dual-plasma fuel cell to build and transform this fuel cell into the [GerTh. I] dual-plasma jet thruster. Their motion principles are according to the electromagnetic right-hand rule. And their plasmas are ejected out from the opposite sides of ionizing chambers [471] & [473] and vertically through the opening end field [451] of the ‘C’ shaped magnet [450].

2. Operation of the Preferred Innovations

As shown, as in FIG. (1), first we switch the normally-opened starter/igniter interlock switches close. Let high voltage starter battery charge the electrodes and inlet gases in ionizing chambers. Then, use the ignition system to start the combustion process of the charged hydrogen and oxygen plasmas in the combustion & neutralization space. The combustion heat will transform molecules into plasmas gradually during the warm-up time period. After temperatures are reached, the warm-up process is done and the dual-plasma fuel cell will generate the steady plasmas' flows by its combustion heat, instead of by the former starter battery's high electric voltage. Then, switch ‘OFF’ the starter/igniter interlock switches, and turn the operation load switch ‘ON’ at the same time. Then, start running the fuel cell, and generate electricity by continuously supplying fuel and oxygen into the unit.

The multiple-stage low-temperature heat exchanger is for the steam-gas-liquid gases' heat exchanging and the grounding grids prevent liquid gases from being the electrified media down back into the storage tanks. Those are insulated from the fuel cell's furnace by connecting them with the ceramic tubing between the fuel cell's furnace and the low-temperature heat exchanger. And the furnace inner wall is made of high-temperature-resistant Tantalum (Ta) and it works like the high-temperature heat exchanger to conduct heat from the flame and high temperature steam to the gases hydrogen and oxygen to elevate their temperatures. Then, the hydrogen and oxygen hot gases are guided separately through heating baffle fins to their atomizing chambers to be atoms which fins are also made of high-temperature-resistant Tantalum (Ta) alloys.

After the atomizing chambers are the ionizing chambers, which are located at the ends of the atomizing chambers. The electrodes are located at the middle sections of the ionizing chambers. Cable is connected among the electrodes in the ionizing chambers, and electric loads conduct and consume the generated electric current and power.

To get plasmas combusted and neutralized the ‘+’, & ‘−’ Charge-Coupled Plasmas, we guide the ‘+’, & ‘−’ Dual-Plasma flows toward each other and are ignited to be combusted & neutralized. Then, they release tremendous heat which can be re-supplying the heat needed for atomizing and ionizing the hydrogen and oxygen molecules.

Finally, the joints between the ionizing chambers and the ionizing pipes (which are composed of metal and ceramic rings for insulation and avoid from abnormal electric shocks) and the joints are made of compacted rings which look like and work like piston rings, but those piston rings are connected back to back with no space in between for preventing plasmas leakage. The compacted rings form a gas-tight seal to prevent leakage. The diagram of the compacted rings is shown in the prior art.

High-temperature-resistant joint insulation sealing (mechanically be compacted rings and ceramic portion) eliminates any leakage due to the different thermal expansions between the Tantalum (Ta) alloys' wall and the outlet pipes.

The nuclear radiation hazard and electric insulation are two main seriously public safety demands. Their implementations are under serious considerations. The robust robots will be the good choices for operating the nuclear waste treatment. The skilled-in-art agents may have some other modifications down the road, contemplatively.

The foregoing descriptions of specific innovations of the present invention are presented for purposes of illustration and applications. They are not intended to be exhaustive or to limit the invention to the precise forms disclosed, and obviously other modifications are possible in light of the above disclosure. The innovations of the [GOD, I], [GOD, II], & [GOD, III] dual-plasma fuel cells were chosen and described in order to best explain the motive power principles of the [GerTh. I] dual-plasma jet thruster for its practical power sources and other major civil utility applications. It is intended that the scopes of these inventions are defined by the claims appended hereto and their equivalents. Therefore, the scopes of these inventions are to be limited only by the following claims.

What claimed are:

1. A dual-plasma fuel cell comprising:
an automatically electric starting system;
a pair of fuel sources having two ionizable fuels;
a pair of ionization chambers, each one of said chambers coupled to receive one of said plasma fuels, respectively;
a pair of ejection portals, each one of said portals depending from one of said ionization chambers;
a space disposed between said ionizing chambers for combustion & neutralization of said fuels; and wherein the combustion of said ionized fuels generates thermal energy for heating said chambers and initializing the next plasmas-generation cycle.

2. The dual plasma fuel cell of claim 1, further comprising:
fusion fuel means for providing additional nuclear-thermal energy for heating said chambers and initializing a next plasmas-generation cycle.

3. The dual-plasma fusion fuel cell of claim 2, further comprising:
heavy water [D₂O] injection means into said atomizing chambers.

4. The dual-plasma fusion fuel cell of claim 3, wherein said heavy water [D₂O] injection means further comprises reaction of un-like charges of the heavy water's [D₂O⁺], & [D₂O⁻] with plasmas' [2H⁺& O⁼], wherein said combustion heating which inducing the fusion reaction and releasing more nuclear heating power for initiation of more plasmas generation easily for the next plasmas-generation cycle.

5. The dual-plasma fusion fuel cell of claim 4, further comprising:
electrical power generation from said nuclear-thermal-plasmas reaction by exothermal heating from combustion & nuclear reactions utilizing conducting high-electrons' current, the cable, loads, and electrodes in electrical communication among one another between two plasmas' ionizing chambers.

6. The dual-plasma fuel cell of claim 1, wherein said fission fuel means comprise concentrated cemented fission fuel sticks.

7. The dual-plasma fission fuel cell of claim 6, further comprising:
a crucible beneath said fuel sticks; and
a plurality of Lead (Pb) tubes disposed inside said crucible;
wherein as said concentrated reacting fuel sticks are melted into a molten metal, said molten metal flows into said Lead (Pb) tubes as heating and radiation moderator, whereby water is in fluid communication with said Lead (Pb) tubes for absorbing fission heat and cooling down of said Lead (Pb) tubes.

8. The dual-plasma nuclear fuel cells as of claim 3, further comprising:
a ‘C’ shaped magnet for plasmas ejected through its opening magnetic field generates the linear thrust for propulsion; and
a nozzle for discharging the combustion exhaustion;
wherein the combustion of said ionized fuels generates auxiliary-thrust when discharged from the said nozzle;
whereby said combination forms a dual plasmas thruster.

9. The dual-plasma nuclear fuel cells as of claim 6, further comprising:
a ‘C’ shaped magnet for plasmas ejected through its opening magnetic field generates the linear thrust for propulsion; and
a nozzle for discharging the combustion exhaustion;
wherein the combustion of said ionized fuels generates auxiliary-thrust when discharged from the said nozzle;
whereby said combination forms a dual plasmas thruster.

10. The dual-plasma jet thruster of claim 8, further comprising:
nuclear fuel means for providing additional nuclear-thermal energy for heating said chambers and initializing the next plasmas-generation cycle.

11. The dual-plasma jet thruster of claim 10, further comprising:
heavy water [D₂O] injection means into said atomizing chambers.

12. The dual-plasma jet thruster of claim 9, further comprising:
nuclear fuel means for providing additional nuclear-thermal energy for heating said chambers and initializing the next plasmas-generation cycle.
